(19) United States
(12) Patent Application Publication
(10) Pub. No.: US 2022/0299915 A1
(43) Pub. Date: Sep. 22, 2022

(54) IMAGE FORMING APPARATUS

(71) Applicant: SHARP KABUSHIKI KAISHA, Sakai City (JP)

(72) Inventor: Shinji YAMANA, Sakai City (JP)

(21) Appl. No.: 17/692,600

(22) Filed: Mar. 11, 2022

(30) Foreign Application Priority Data
Mar. 19, 2021 (JP) 2021-045935

(51) Int. Cl. G03G 15/20

(52) U.S. Cl. CPC G03G 15/2039

(57) ABSTRACT

An image forming apparatus includes a fixation belt that catches and conveys a sheet of paper, a heat source that heats the fixation belt, a temperature controlling section that decides an instruction to the heat source for each control cycle for controlling the temperature of the fixation belt, a temperature sensor that converts the temperature of the fixation belt into a digital value to detect the temperature of the fixation member as temperature data, a communications section that communicates with the temperature sensor according to the control cycle to acquire the temperature data, and a temperature calculating section that calculates the temperature to be acquired, based on the temperature data. The communications section performs a restoration process if a communication fault has occurred. The temperature calculating section performs a complementary process for complementing the temperature to be acquired.

### BACKGROUND OF THE INVENTION

### Field of the Invention

The present invention relates to an image forming apparatus that fixes a toner image on a sheet of paper to carry out image formation.

### Description of the Background Art

Conventionally, in an image forming apparatus, a toner image is fixed onto a sheet of paper by heating, and the temperature is detected by a temperature sensor in order to appropriately adjust the temperature. In recent years, the method is proposed, in which the result of detection by a temperature sensor is converted into a digital value and as such fetched by a computer, and the digital value is converted by the computer into the temperature of a fixation roller so as to detect the temperature (see JP 2004-28622 A, for instance).

The temperature detection device as described in JP 2004-28622 A uses a noncontact temperature detection means including a film that absorbs infrared rays from a target of temperature detection, a heat sensitive element for infrared detection that detects the temperature of the film, and a heat sensitive element for temperature compensation that detects the temperature of a holder holding the film, and the temperature detection device includes a first breakdown detection means that detects breakdowns of the heat sensitive element for infrared detection and a transmission line of the heat sensitive element for infrared detection, and a second breakdown detection means that detects breakdowns of the heat sensitive element for temperature compensation and a transmission line of the heat sensitive element for temperature compensation.

In the temperature detection device as above, breakdowns of the heat sensitive elements and the transmission lines are detected. In digital data communication, however, it is feared that the influence of an electrostatic noise generated in the device will cause a communication error (communication fault), which makes the temperature detection impossible.

The present invention has been made in order to solve the above problem and is aimed at providing an image forming apparatus improved in reliability by carrying out temperature acquisition coping with communication faults.

### SUMMARY OF THE INVENTION

An image forming apparatus according to the present invention is an image forming apparatus that fixes a toner image on a sheet of paper to carry out image formation, and includes: a fixation member that catches and conveys the sheet of paper; a heat source that heats the fixation member; a temperature controller that decides an instruction to the heat source for each control cycle for controlling a temperature of the fixation member; a temperature sensor that converts the temperature of the fixation member into a digital value to detect the temperature of the fixation member as temperature data; a communicator that communicates with the temperature sensor according to the control cycle to acquire the temperature data; and a temperature calculator that calculates a temperature to be acquired, based on the temperature data. The communicator performs a restoration process for attempting to restore communication if a communication fault has occurred in communication with the temperature sensor. If the temperature data is not acquired in the control cycle, the temperature calculator performs a complementary process for calculating the temperature to be acquired from the temperature data acquired before occurrence of the communication fault to complement the temperature to be acquired.

The image forming apparatus according to the present invention may have a configuration where, if the communication has been restored by the restoration process within a period of the control cycle, the temperature calculator calculates the temperature to be acquired based on the temperature data acquired in the control cycle.

The image forming apparatus according to the present invention may have a configuration where the temperature calculator calculates the temperature to be acquired in the complementary process based on the temperature data acquired immediately before the occurrence of the communication fault.

The image forming apparatus according to the present invention may have a configuration where the temperature calculator estimates, in the complementary process, temperature change over time from a plurality of pieces of the temperature data acquired before the occurrence of the communication fault to calculate the temperature to be acquired.

The image forming apparatus according to the present invention may have a configuration where the temperature calculator sets a reference value for the temperature data and calculates the temperature to be acquired based on a mean value obtained by excluding the temperature data, whose value differs from the reference value with a defined disparity or a disparity greater than the defined disparity.

The image forming apparatus according to the present invention may have a configuration where the fixation member has a layer containing a conductive material.

The image forming apparatus according to the present invention may have a configuration where the temperature calculator sets a reference value for the temperature data and cancels the temperature data, whose value differs from the reference value with a defined disparity or a disparity greater than the defined disparity, to determine that the temperature data is not acquired.

The image forming apparatus according to the present invention may have a configuration where a notifier that gives notification to a user according to an instruction from the temperature controller is included and the temperature calculator counts a number of times of error occurrence if the temperature data is not acquired and causes the notifier to notify of an error if the number of times of error occurrence exceeds a threshold.

The image forming apparatus according to the present invention may have a configuration where the threshold is set with respect to a number of times of error occurrence successively counted, and the notifier gives notification that control of the temperature of the fixation member is abnormal.

The image forming apparatus according to the present invention may have a configuration where the threshold is set with respect to a number of times of error occurrence integrally counted, and the notifier gives notification that a breakdown has been caused or is nearly caused.

According to the present invention, the temperature to be acquired is calculated and complemented if the temperature data cannot be acquired even after the restoration process when a communication fault has occurred, so that temperature acquisition is improved in reliability.

### BRIEF DESCRIPTION OF THE DRAWINGS

FIG. 1 is a schematic side view of an image forming apparatus according to an embodiment of the present invention.

FIG. 2 is an enlarged side view exclusively illustrating a fixation device in the image forming apparatus illustrated in FIG. 1.

FIG. 3 is a schematic block diagram of the image forming apparatus according to the embodiment of the present invention.

FIG. 4 is an enlarged side view of a fixation belt.

FIG. 5A is a diagram illustrating temperature data acquired if recovery from a communication fault has been achieved within a period of a control cycle.

FIG. 5B is a diagram illustrating the temperature data, which is acquired if the recovery from the communication fault is not achieved within the period of the control cycle.

FIG. 6 is a flowchart illustrating a flow of processing performed when the temperature is controlled in the image forming apparatus.

### DESCRIPTION OF THE PREFERRED EMBODIMENTS

In the following, an image forming apparatus according to an embodiment of the present invention is described with reference to the accompanying drawings.

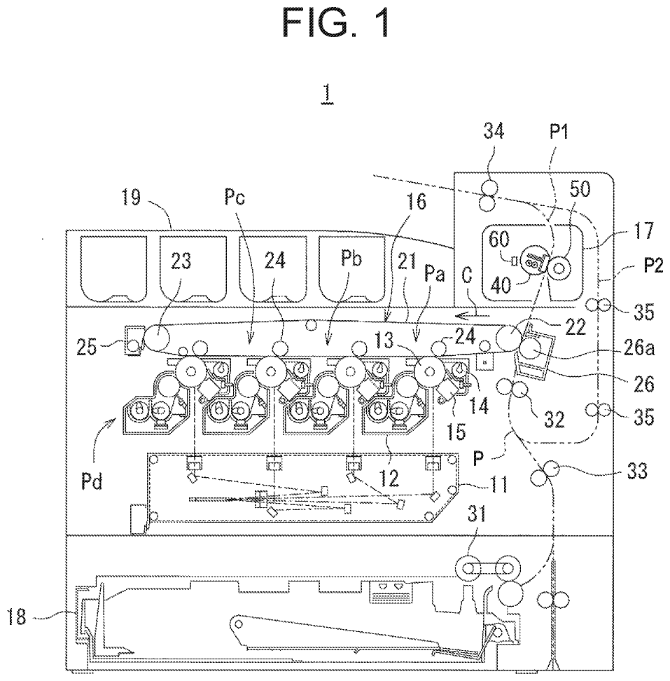

FIG. 1 is a schematic side view of an image forming apparatus according to an embodiment of the present invention.

An image forming apparatus 1 according to an embodiment of the present invention has a configuration including an exposure device 11, a development device 12, a photosensitive drum 13, a cleaner 14, an electrifier 15, an intermediate transfer belting 16, a fixation device 17, a paper feed tray 18, a paper discharge tray 19, and a sheet conveyance path P, and forms polychrome and monochrome images on specified sheets of paper according to image data transmitted from the outside.

The image data, which is dealt with in the image forming apparatus 1, is image data corresponding to the color image, for which four colors of black (K), cyan (C), magenta (M), and yellow (Y) are used. Therefore, the development device 12, the photosensitive drum 13, the electrifier 15, and the cleaner 14 as provided are each four in number so that four latent images corresponding to the four colors, respectively, may be formed. The four development devices 12 are assigned to black, cyan, magenta, and yellow, respectively, with the same applying to the four photosensitive drums 13, the four electrifiers 15, and the four cleaners 14. The development devices 12, the photosensitive drums 13, the electrifiers 15, and the cleaners 14 as such constitute four image stations Pa, Pb, Pc, and Pd.

The photosensitive drums 13 are arranged almost in a center of the image forming apparatus 1. The electrifiers 15 uniformly electrify surfaces of the photosensitive drums 13 to a specified potential. The exposure device 11 exposes the surfaces of the photosensitive drums 13 so as to form electrostatic latent images. The development devices 12 develop the electrostatic latent images on the surfaces of the photosensitive drums 13 so as to form toner images on the surfaces of the photosensitive drums 13. By a series of operations as above, toner images in the respective colors are formed on the surfaces of the respective photosensitive drums 13. The cleaners 14 remove and collect residual toner on the surfaces of the photosensitive drums 13 after the development and image transfer.

The intermediate transfer belting 16 is arranged on an upper side of the photosensitive drums 13 and includes an intermediate transfer belt 21, an intermediate transfer belt driving roller 22, an intermediate transfer belt driven roller 23, intermediate transfer rollers 24, and an intermediate transfer belt cleaning device 25. The intermediate transfer rollers 24 are provided correspondingly to the image stations Pa, Pb, Pc, and Pd for the respective colors Y, M, C, and K and are accordingly four in number.

The intermediate transfer belt driving roller 22, the intermediate transfer belt driven roller 23, and the intermediate transfer rollers 24 are so formed as to allow the intermediate transfer belt 21 to be stretched on the rollers 22, 23, and 24 and move a surface of the intermediate transfer belt 21 in a specified direction (direction indicated by an arrow C in FIG. 1).

The intermediate transfer belt 21 runs in circles in the direction of the arrow C and is cleaned by the intermediate transfer belt cleaning device 25 so as to remove and collect residual toner, and the toner images in the respective colors as formed on the surfaces of the respective photosensitive drums 13 are sequentially transferred and superposed so as to form a color toner image on the surface of the intermediate transfer belt 21.

The image forming apparatus 1 further includes a secondary transfer device 26 including a transfer roller 26a. A nip area is formed between the transfer roller 26a and the intermediate transfer belt 21, and the transfer roller 26a catches a sheet of paper conveyed and arrived through the sheet conveyance path P in the nip area and conveys the sheet of paper. The toner image on the surface of the intermediate transfer belt 21 is transferred onto the sheet of paper passing through the nip area.

The paper feed tray 18 is a tray for storing sheets of paper to be used for image formation, and is provided on a lower side of the exposure device 11. The paper discharge tray 19 is provided in an upper portion of the image forming apparatus 1 as a tray that a sheet of paper with an image formed thereon is to be placed on.

The sheet conveyance path P includes a main path P1 provided in an S-shape and a reverse path P2 that diverges halfway from the main path P1 and then rejoins the main path P1. Along the main path P1, a pickup roller 31, a preliminary register roller 33, a register roller 32, the secondary transfer device 26, the fixation device 17, and a paper discharge roller 34 are arranged. The reverse path P2 diverges from the main path P1 between the fixation device 17 and the paper discharge roller 34, goes via a plurality of conveyance rollers 35, and rejoins the main path P1 between the preliminary register roller 33 and the register roller 32.

The pickup roller 31 is an introduction roller that is provided in the vicinity of an end portion of the paper feed tray 18 so as to feed the sheets of paper from the paper feed tray 18 to the sheet conveyance path P one by one. The register roller 32 temporarily holds a sheet of paper conveyed from the paper feed tray 18, then conveys the sheet of paper to the transfer roller 26a with timing allowing a tip of the sheet of paper to coincide with tips of the toner images on the photosensitive drums 13. The preliminary register roller 33 is a small-sized roller for facilitating and assisting the conveyance of sheets of paper.

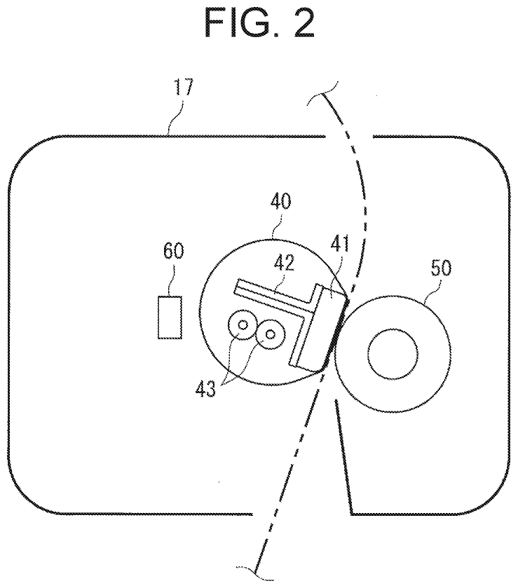

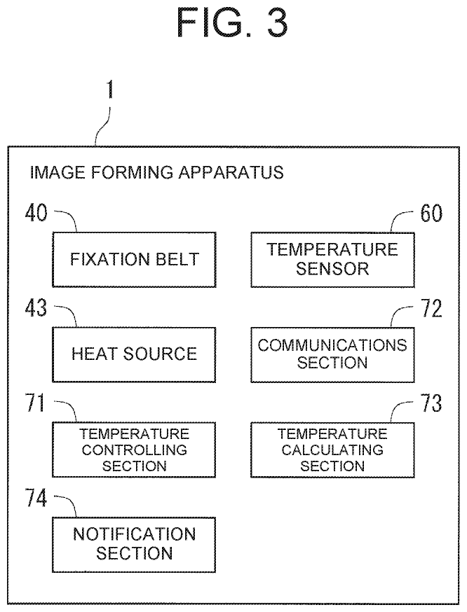

The fixation device 17 operates on a belt fixation system and has a configuration where a pressure roller 50 is pressed against a fixation belt 40 (an exemplary fixation member). In the vicinity of the fixation belt 40, a temperature sensor 60 is provided. In the fixation device 17, a sheet of paper with an unfixed toner image formed thereon is received, and the sheet of paper is caught and conveyed between the fixation belt 40 and the pressure roller 50. The sheet of paper after fixation is discharged by the paper discharge roller 34 onto the paper discharge tray 19. The fixation device 17 will be detailed later with reference to FIGS. 2 and 3.

If image formation is to be carried out not only on a front face but a back face of a sheet of paper, the sheet of paper is oppositely conveyed from the paper discharge roller 34 to the reverse path P2 so as to reverse the sheet of paper, guide the sheet of paper again to the register roller 32, and subject the back face to image formation similarly to the front face, then the sheet of paper is conveyed and discharged to the paper discharge tray 19.

FIG. 2 is an enlarged side view exclusively illustrating the fixation device 17 in the image forming apparatus 1 illustrated in FIG. 1.

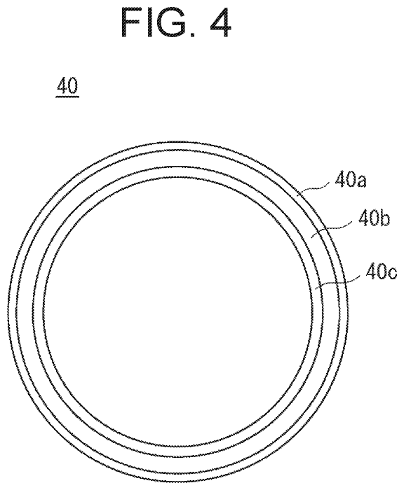

The fixation belt 40 is an endless (tubular), heat-resistant belt capable of running in circles. A detailed configuration of the fixation belt 40 will be described later with reference to FIG. 4. On an inner peripheral face side (that is to say, in the inside) of the fixation belt 40, a nip forming member 41, a support member 42, and a heat source 43 are arranged.

The nip forming member 41 is provided in a position opposite to the pressure roller 50, with the fixation belt 40 being sandwiched between the nip forming member 41 and the pressure roller 50, and is in pressure contact with the fixation belt 40 from inside. As a result of the pressing by the nip forming member 41 and the pressure roller 50, a nip area where a toner image is fixed onto a sheet of paper is formed on a surface of the fixation belt 40. The support member 42 supports the nip forming member 41 on the opposite side from the nip area and thus holds the nip forming member 41 so that the nip forming member 41 may press the fixation belt 40 with a specified force. The heat source 43 is a heater lamp, for instance, and is so provided inside the fixation belt 40 as not to come into contact with the members 41 and 42.

Inside the fixation belt 40, a protective member or a reflection plate may be provided besides the components as above. The protective member is provided between the heat source 43 and the fixation belt 40 so as to prevent the heat source 43 and the fixation belt 40 from coming into direct contact with each other. The reflection plate is provided between the support member 42 and the heat source 43 so as to reflect heat generated from the heat source 43 onto the fixation belt 40 and thus allow the fixation belt 40 to be efficiently heated. It is also possible to wind a sliding sheet around the nip forming member 41 so as to reduce friction generated between the nip forming member 41 and the fixation belt 40.

The temperature sensor 60 may be provided in two or more different positions in a width direction of sheets of paper (direction where a rotation axis of the pressure roller 50 extends). In the present embodiment, the temperature sensor 60 is provided in a center and at one end in the width direction. The temperature sensor 60 is assumed as a digital sensor that converts the temperature of the fixation belt 40 into a digital value so as to detect the temperature as temperature data.

FIG. 3 is a schematic block diagram of the image forming apparatus 1 according to the embodiment of the present invention.

The image forming apparatus 1 includes a temperature controlling section 71, a communications section 72, a temperature calculating section 73, and a notification section 74 besides the fixation belt 40, the heat source 43, and the temperature sensor 60 as described above. In FIG. 3, part of the image forming apparatus 1 is exclusively illustrated and the rest is omitted.

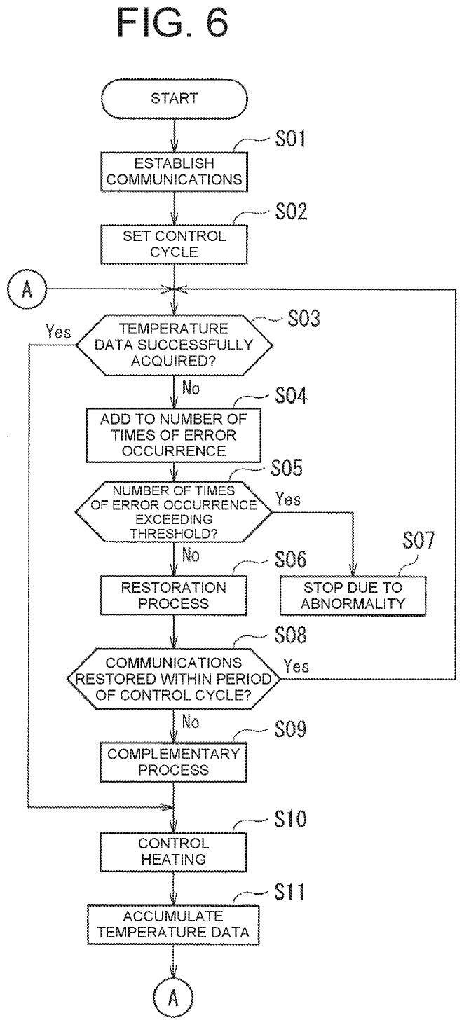

The temperature controlling section 71 controls the temperature of the fixation belt 40. Temperature control by the temperature controlling section 71 will be detailed later with reference to FIG. 6.

The communications section 72 communicates with the temperature sensor 60 so as to acquire the temperature data and performs a restoration process for attempting to restore the communication with the temperature sensor 60 if a communication fault has occurred in the communication. In the present embodiment, the communications section 72 uses inter-integrated circuit (I2C) communication with respect to the temperature sensor 60 to acquire the temperature data, and executes resetting, retrying, and the like of communication in the restoration process.

The temperature calculating section 73 calculates a temperature to be acquired, based on the temperature data. In other words, the temperature calculating section 73 calculates the temperature to be acquired, which corresponds to the temperature of the fixation belt 40, by conversion from a value of the temperature data or the like.

The notification section 74 gives notification to a user according to an instruction from the temperature controlling section 71 or the like. For the notification, light, sound, an image, and the like are usable, and a speaker, a light emitter, a display or the like is provided according to the notification method.

FIG. 4 is an enlarged side view of the fixation belt 40.

In the present embodiment, the fixation belt 40 is formed by stacking a plurality of layers. Specifically, the fixation belt 40 has a surface layer 40a, an elastic layer 40b, and a base layer 40c in this order from an outer peripheral face side (that is to say, from outside). The surface layer 40a is formed of a fluororesin such as perfluoroalkyl (PFA), for instance. The elastic layer 40b is formed of silicone rubber, for instance. The base layer 40c is formed of a polyimide or metal, for instance.

If the base layer 40c is not formed of metal as a conductive material, a conductive material may be imparted to a polyimide or a conductive material may be imparted to the elastic layer 40b. Thus providing a layer containing a conductive material in the fixation belt 40 makes it possible to lower the resistance of the fixation belt 40 so as to reduce noises, which improves the accuracy of temperature detection.

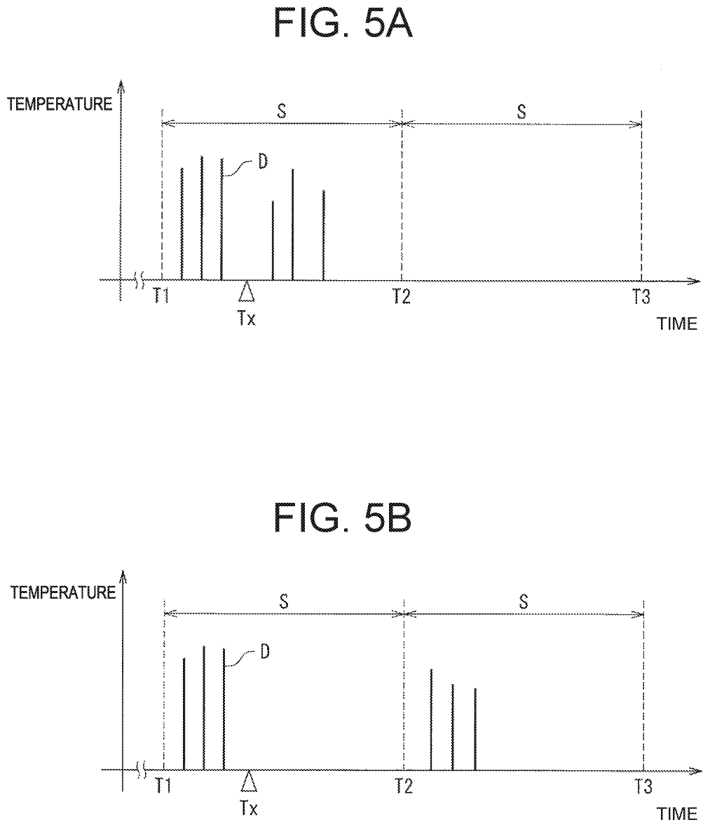

Next, the relationship of the temperature data detected by the temperature sensor 60 and the temperature control by the temperature controlling section 71 to the time when a communication fault has occurred is described with reference to FIGS. 5A and 5B.

FIG. 5A is a diagram illustrating temperature data acquired if recovery from a communication fault has been achieved within a period of a control cycle.

In FIG. 5A, the horizontal axis shows the elapse of time and the vertical axis the temperature. The temperature in the figure is an indicator of whether the communications section 72 has received temperature data D, and a vertical size of a line representing the temperature schematically indicates the magnitude of the temperature.

The temperature sensor 60 acquires the temperature data D every several microseconds. In the image forming apparatus 1, a control cycle S for controlling the temperature of the heat source 43 and the like is set, and the communications section 72 acquires, for each control cycle S, the temperature data D in the relevant cycle collectively. In the present embodiment, the control cycle S is set to be 50 to 2000 milliseconds. Generally, the temperature sensor 60 is capable of acquiring the temperature data D two or more times in the control cycle S.

If communications are established between the temperature sensor 60 and the communications section 72, it can be comprehended that the temperature data D is acquired, whereas the temperature data D cannot be acquired if a communication fault occurs. In the latter case, the restoration process is performed so as to attempt to restore the communications.

In an example illustrated in FIG. 5A, the temperature is controlled at a time T1, a time T2, and a time T3, with a period from the time T1 to the time T2 and a period from the time T2 to the time T3 each corresponding to the control cycle S.

In the example illustrated in FIG. 5A, a communication fault occurs at a time Tx during the period from the time T1 to the time T2. Until the time Tx, any particular problems do not arise, so that the temperature data D is continuously acquired. After the time Tx, a brief period of time for which the temperature data D cannot be acquired is present indeed, but communication is immediately restored and the temperature data D becomes acquirable before the time T2. While the temperature data D is omitted around the time T2 and between the time T2 and the time T3 in FIG. 5A, the temperature data D is actually able to be continuously acquired after the restoration of communication.

FIG. 5B is a diagram illustrating the temperature data D, which is acquired if the recovery from the communication fault is not achieved within the period of the control cycle S.

Almost similarly to FIG. 5A, FIG. 5B illustrates how the temperature data D is acquired in course of time, while the time, at which communication is restored after the communication fault occurs at the time Tx, is different.

To be specific: In FIG. 5B, the communication fault occurs indeed at the time Tx during the period from the time T1 to the Time T2, as is the case with FIG. 5A, but communication is restored after the time T2. In other words, the temperature data D cannot be acquired at the time T2, which corresponds to the control cycle S. Similarly to FIG. 5A, the temperature data D is partially omitted in FIG. 5B, while the temperature data D is actually able to be continuously acquired after the restoration of communication.

FIG. 6 is a flowchart illustrating a flow of processing performed when the temperature is controlled in the image forming apparatus 1.

In the flow of the processing illustrated in FIG. 6, the initial state is assumed as a state before starting temperature control, which is not limitative. The initial state may be a state where the temperature is under control and an operation is just about to transfer to another operation.

In step S01, communication with the temperature sensor 60 is established by the communications section 72. In this step, an instruction to output the temperature data D is given from the communications section 72 to the temperature sensor 60.

In step S02, the control cycle S is set by the temperature controlling section 71. After the control cycle S is set, time having elapsed is suitably measured with a timer or the like.

In step S03, it is determined by the communications section 72 whether the temperature data D has been acquired. In this step, it is determined whether there has arisen a state where the temperature data D cannot be acquired under the influence of a communication fault or the like, even though in the control cycle S. As a result, the processing proceeds to step S10 if the temperature data D has been acquired (Yes in step S03). If the temperature data D cannot be acquired (No in step S03), the processing proceeds to step S04.

In step S04, addition to the number of times of error occurrence is performed by the temperature controlling section 71. In this regard, the fact that the temperature data D cannot be acquired is assumed as an error, and the temperature controlling section 71 performs counting on a plurality of items related to the number of times of error occurrence. Specific examples of the items include the number of times of successive error occurrence, which is the number of times the error has successively occurred, and the integrated number of times of error occurrence as the number of times the error has occurred per day. In addition to the above, the lifetime total number of times of error occurrence, which is the total number of times the error has occurred, may be counted.

In step S05, it is determined by the temperature controlling section 71 whether the number of times of error occurrence exceeds a threshold. With respect to the number of times of error occurrence, a threshold is set for each item and it is determined that the number of times of error occurrence exceeds its threshold if any one item exceeds the threshold of its own. As a result, the processing proceeds to step S07 if the number of times of error occurrence exceeds the threshold (Yes in step S05). If the number of times of error occurrence does not exceed the threshold (No in step S05), the processing proceeds to step S06.

In step S06, the restoration process is performed by the communications section 72. As to the restoration process, a known restoration process with the I2C communication can be performed.

In step S07, an instruction to cause the image forming apparatus 1 to stop due to abnormality is given by the temperature controlling section 71 so as to terminate the processing. The notification section 74 gives notification that the control of the temperature of the fixation belt 40 is abnormal, if the number of times of successive error occurrence exceeds the threshold. If the integrated number of times of error occurrence exceeds the threshold, the notification section 74 gives notification that the image forming apparatus 1 has broken down or nearly breaks down.

In step S08, it is determined by the temperature controlling section 71 whether communication has been restored within the period of the control cycle S. In other words, it is determined whether the temperature data D is acquired with timing corresponding to the control cycle S, with the case illustrated in FIG. 5A corresponding to the case, in which communication has been restored within the period of the control cycle S, and the case illustrated in FIG. 5B corresponding to the case, in which communication has not been restored within the period of the control cycle S. As a result of the determination, the processing returns to step S03 if communication has been restored within the period of the control cycle S (Yes in step S08). If communication has not been restored within the period of the control cycle S (No in step S08), the processing proceeds to step S09.

In step S09, a complementary process for calculating and complementing the temperature to be acquired is performed by the temperature calculating section 73. In the complementary process, the temperature to be acquired is calculated from the temperature data D acquired before the occurrence of a communication fault. As to the method for calculating the temperature to be acquired, one of the methods to be described later is applied.

In step S10, heating is controlled by the temperature controlling section 71. In this step, based on the temperature to be acquired, which is calculated from the temperature data D, instructions given to respective parts are decided so as to control the temperature of the fixation belt 40.

In step S11, the temperature data D is accumulated by the temperature controlling section 71. In this step, a value of the temperature data D is associated with the time, at which the temperature data D has been acquired, and as such stored so as to accumulate the temperature data D so that temperature change over time may be comprehended. After step S11, the processing returns to step S03, and the temperature data D is acquired so as to continue the processing for controlling the temperature.

Next, a detailed description is made on the method for calculating the temperature to be acquired.

If no communication faults occur, the temperature data D is acquired in the control cycle S, so that, as a first method, the temperature to be acquired is calculated based on the acquired temperature data D and reflected in the control of the temperature of the fixation belt 40.

If a communication fault has occurred and communication has been restored within the period of the control cycle S, as a second method, the temperature to be acquired is calculated based on the acquired temperature data D and reflected in the temperature control, as is the case with the first method.

If a communication fault has occurred and communication has not been restored within the period of the control cycle S, as a third method, the temperature to be acquired is calculated based on the temperature data D acquired immediately before the occurrence of the communication fault. To explain using, as an example, the case illustrated in FIG. 5B, a communication fault occurs at the time Tx, so that, at the time T2, the temperature to be acquired, which is calculated based on the temperature data D acquired immediately before the time Tx, is reflected in the temperature control. If the temperature is to be estimated in such manner, deviation from an actual temperature is avoided by referring to the most recent temperature data D out of the acquired temperature data D.

If a communication fault has occurred and communication has not been restored within the period of the control cycle S, a fourth method or a sixth method, both to be described below, may be applied instead of the third method as above.

The fourth method is different from the third method in that the temperature to be acquired is calculated based on a plurality of pieces of temperature data D acquired before the occurrence of a communication fault. To be specific: When a temperature based on the temperature data D immediately before the occurrence of a communication fault is represented by D1 and a temperature based on the temperature data D just before D1 is represented by D2, the last temperature difference ΔD1 is calculated with an equation “ΔD1=D1−D2”. A temperature ST to be acquired is calculated by taking into account the last temperature difference ΔD1 besides the preceding temperature data D, as expressed by an equation “ST=D1+ΔD1”.

A fifth method is different from the fourth method in that the temperature to be acquired is calculated by taking into account the temperature data D, which has been acquired earlier. To be specific: When a temperature based on the temperature data D just before D2 is represented by D3, the next to last temperature difference ΔD2 is calculated with an equation “ΔD2=D2−D3”. The temperature ST to be acquired is calculated by taking into account the next to last temperature difference ΔD2 and accelerative elements as well, as expressed by an equation “ST=D1+2×ΔD1−ΔD2”.

Thus in the complementary process, temperature change over time may be estimated from the pieces of temperature data D acquired before the occurrence of a communication fault so as to calculate the temperature to be acquired. In other words, the deviation from an actual temperature can be avoided by estimating the temperature to be acquired from the acquired temperature data D by taking into account the temperature change over time.

In the sixth method, a mean of a plurality of pieces of temperature data D is found so as to calculate the temperature to be acquired. The pieces of temperature data D are appropriately extracted in order of proximity to a communication fault in time, and are about five in number, for instance.

During the acquisition of pieces of temperature data D, those pieces each having a deviating value may be excluded. Specifically, a mean of a plurality of pieces of temperature data D acquired within a specified period of time is found so as to set a reference value. A piece of temperature data D whose value differs from the reference value with a defined disparity or a disparity greater than the defined disparity is excluded. If the number of excluded pieces is at a ratio higher than 50% with respect to the total number of the pieces of temperature data D acquired within the specified period of time, an error signal may be output.

In the sixth method as above, it is also possible to exclude deviating values before calculating a mean value of the pieces of temperature data D. During the temperature detection, a piece of temperature data D acquired may have a protuberant value that is quite different from the value of an actual temperature, under the influence of noises or the like, so that it is possible to improve the accuracy of temperature estimation by excluding such piece of temperature data D with low reliability before calculating the mean value.

As described above, the temperature to be acquired is calculated and complemented if the temperature data D cannot be acquired even after the restoration process when a communication fault has occurred, so that temperature acquisition is improved in reliability. If the communication fault has been settled by the restoration process, appropriate temperature data D is acquired and reflected in the temperature control.

In the present embodiment, the temperature sensor 60 is provided in two different places in the width direction, so that it is also possible to consider the temperature data D obtained from each of two temperature sensors 60 so as to calculate the temperature to be acquired. Temperature difference due to the positions, in which the temperature sensors 60 are provided, is estimated in advance, and the temperature to be acquired is calculated by taking into account the estimated temperature difference. If the temperature difference due to the positions, in which the temperature sensors 60 are provided, is made considerable by the size of a sheet of paper for image formation, the temperature data D from the temperature sensor 60, which is provided at an end, may be ignored.

The embodiment disclosed herein is an example in all respects and gives no grounds for a limited interpretation. Therefore, a technical scope of the present invention is not interpreted solely based on the embodiment as described above but is demarcated on the basis of the recitals in the claims. All modifications equivalent to the claims in meaning and scope fall within the scope of the present invention.

What is claimed is:

1. An image forming apparatus that fixes a toner image on a sheet of paper to carry out image formation, the apparatus comprising:
a fixation member that catches and conveys the sheet of paper;
a heat source that heats the fixation member;
a temperature controller that decides an instruction to the heat source for each control cycle for controlling a temperature of the fixation member;
a temperature sensor that converts the temperature of the fixation member into a digital value to detect the temperature of the fixation member as temperature data;
a communicator that communicates with the temperature sensor according to the control cycle to acquire the temperature data; and
a temperature calculator that calculates a temperature to be acquired, based on the temperature data,
wherein the communicator performs a restoration process for attempting to restore communication if a communication fault has occurred in communication with the temperature sensor, and
wherein, if the temperature data is not acquired in the control cycle, the temperature calculator performs a complementary process for calculating the temperature to be acquired from the temperature data acquired before occurrence of the communication fault to complement the temperature to be acquired.

2. The image forming apparatus according to claim 1, wherein, if the communication has been restored by the restoration process within a period of the control cycle, the temperature calculator calculates the temperature to be acquired based on the temperature data acquired in the control cycle.

3. The image forming apparatus according to claim 1, wherein the temperature calculator calculates the temperature to be acquired in the complementary process based on the temperature data acquired immediately before the occurrence of the communication fault.

4. The image forming apparatus according to claim 1, wherein the temperature calculator estimates, in the complementary process, temperature change over time from a plurality of pieces of the temperature data acquired before the occurrence of the communication fault to calculate the temperature to be acquired.

5. The image forming apparatus according to claim 1, wherein the temperature calculator sets a reference value for the temperature data and calculates the temperature to be acquired based on a mean value obtained by excluding the temperature data, whose value differs from the reference value with a defined disparity or a disparity greater than the defined disparity.

6. The image forming apparatus according to claim 1, wherein the fixation member has a layer containing a conductive material.

7. The image forming apparatus according to claim 1, wherein the temperature calculator sets a reference value for the temperature data and cancels the temperature data, whose value differs from the reference value with a defined disparity or a disparity greater than the defined disparity, to determine that the temperature data is not acquired.

8. The image forming apparatus according to claim 1, comprising a notifier that gives notification to a user according to an instruction from the temperature controller,
wherein the temperature calculator counts a number of times of error occurrence if the temperature data is not acquired and causes the notifier to notify of an error if the number of times of error occurrence exceeds a threshold.

9. The image forming apparatus according to claim 8,
wherein the threshold is set with respect to a number of times of error occurrence successively counted, and
wherein the notifier gives notification that control of the temperature of the fixation member is abnormal.

10. The image forming apparatus according to claim 8,
wherein the threshold is set with respect to a number of times of error occurrence integrally counted, and
wherein the notifier gives notification that a breakdown has been caused or is nearly caused.
